(19) United States
(12) Patent Application Publication
(10) Pub. No.: US 2012/0123899 A1
(43) Pub. Date: May 17, 2012

(54) SOCIAL NETWORK SHOPPING SYSTEM AND METHOD

(76) Inventor: Christian WIESNER, Berlin (DE)

(21) Appl. No.: 13/309,737

(22) Filed: Dec. 2, 2011

Related U.S. Application Data
(63) Continuation-in-part of application No. 12/948,032, filed on Nov. 17, 2010.

(51) Int. Cl. G06Q 30/06

(52) U.S. Cl. 705/26.7

(57) ABSTRACT

A product discovery method displaying products and social media in random order from a preselected list. The user provides comments for individual products or social media. Based on user comments, a preselection of products and social media is filtered to the interests of the individual user. The method therefore focuses over time more and more to the real areas of interests of the individual user.

### CROSS-REFERENCE TO RELATED APPLICATION

This application is a continuation-in-part-of patent application Ser. No. 12/948,032, filed Nov. 17, 2010, entitled SOCIAL NETWORK SHOPPING SYSTEM AND METHOD, the entirety of which is incorporated herein by reference.

### STATEMENT REGARDING FEDERALLY SPONSORED RESEARCH OR DEVELOPMENT

n/a

### FIELD OF THE INVENTION

The present invention relates to a computer network services, and in particular, a system and method that combines social networking and on-line shopping functions.

### BACKGROUND OF THE INVENTION

With the wide-spread use of the Internet, more and more people shop on-line for products. For example websites such as Amazon.com and Overstock.com provide many products that may be selected for purchase by a user at a computer terminal. These websites also allow a user to review a product by typing a statement concerning the product and rating the product using stars. However, such shopping websites do not incentivize recommendations, provide an easy way to recommend a product to a friend or track those recommendations. Also anonymous recommendations lack the credibility that a friend's recommendation has, resulting in a low volume of sales arising from the recommendation.

In contrast to shopping websites, social networking websites, such as FACEBOOK and TWITTER, provide users the opportunity to select friends and communicate with friends and others. Although, in principle, while a user may make a shopping recommendation to a friend on a social network site, creating a link to the product to include with the recommendation is time consuming and difficult as such social networks sites do not lend themselves to the support of on-line shopping functions. Here again, such sites do not incentivize making the recommendations.

What is needed is a website that combines features of shopping websites and social networking websites in a single website environment.

### SUMMARY OF THE INVENTION

The present invention advantageously provides a method and system for combining social networking and shopping functions on a wide area network such as the Internet. According to one aspect, the invention provides for storing user information, the user information including user identifying information and product recommendations. At least some of the user information is displayed with links to data concerning recommended products. When a product recommendation is received, the product recommendation is transmitted to one or more designated recipients. When a designated recipient purchases a recommended product, the user who recommended the product receives credit.

According to another aspect, the invention provides a computer system for social networking and shopping combined on a common platform. A computer, having a memory and a processor, stores user information, the user information including user identifying information and user product recommendations. The processor associates a product recommendation with a list of recipients designated by a user. When a designated recipient purchases a recommended product in response to the recommendation, the user who made the recommendations receives credit.

According to yet another aspect, the invention provides a computer readable medium containing computer readable instructions. When executed by a computer, the instructions cause the computer to perform a method for implementing a social network shopping community. The method includes providing a social network website in which the social network website includes a user and friends of the user. A product recommendation from the user and an indication of intended recipients of the product recommendation is received. The intended recipients are selected from the friends of the user. The product recommendation is provided to the intended recipients.

According to another aspect, the invention provides a virtual shopping method. The method includes inviting one or more guests to a shopping tour. The host of the tour selects a virtual store having products for sale. The virtual store is displayed on a computer of the one or more guests. The host further may recommend a product for sale by the virtual store.

According to a further aspect, the invention provides a product discovery method. The method includes displaying products and social media in random order from a preselected list. The user provides comments for individual products or social media. Based on user comments, a preselection of products and social media is filtered to the interests of the individual user. The method therefore focuses over time more and more to the real areas of interests of the individual user.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a network that combines social network and e-commerce functions in accordance with the principles of the present invention;

FIG. 2 is a block diagram of an exemplary computing device constructed in accordance with the principles of the present invention;

FIG. 3 is a flow chart of an exemplary process for receiving product recommendations and crediting a recommending user when a recommended product is purchased by a person who received the recommendation;

FIG. 4 is a flow chart of an exemplary process for receiving and processing a request for recommendation of a product by a user;

FIG. 5 is a flow chart of an exemplary process of a virtual shopping tour in accordance with the principles of the present invention;

FIG. 6 is a flow chart of an exemplary process for soliciting product categories from guests on a virtual shopping tour; and

FIG. 7 is a flow chart of an exemplary process for a product discovery process receiving areas of interest from a user and processing a selection of products and social media according to such areas of interest for the user.

### DETAILED DESCRIPTION OF THE INVENTION

A method and computer system for combining functions of social networking and shopping, i.e., e-commerce, are provided. In one embodiment, a server stores user information including information concerning products recommended by a user. The user may notify a friend or a group of people of a recommended product and receive credit when a friend or member of the group purchases a product based on the recommendation. A user may also take guests on a virtual shopping tour, in which different virtual stores may be visited and different products may be discussed and purchased.

Before describing in detail exemplary embodiments that are in accordance with the present invention, it is noted that the embodiments reside primarily in combinations of apparatus components and processing steps related to implementing a system and method for social networking combined with e-commerce. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

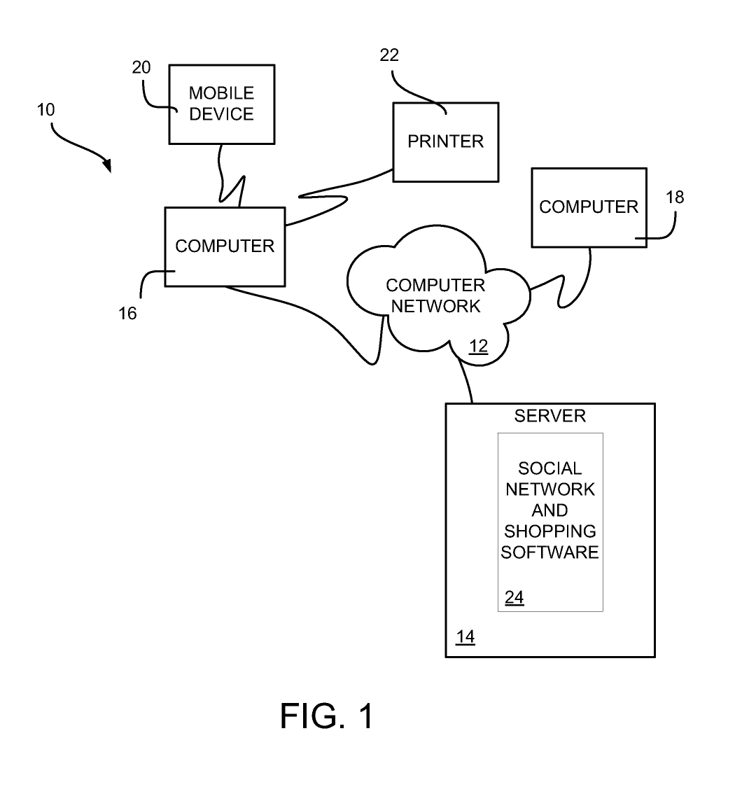

Referring now to the drawing figures in which reference designators refer to like elements, there is shown in FIG. 1 a block diagram of an exemplary system constructed in accordance with the principles of the present invention and designated generally as “10”. System 10 advantageously combines social network and e-commerce functions in accordance with the principles of the present invention. A communications network 12, such as the Internet, is connected to a server 14 and computers 16 and 18. The computer 16 also is connectable to a mobile device 20, such as a mobile phone, personal digital assistant, laptop, etc., and may also be connected to a printer 22. The connections may be wired or wireless. In one embodiment, the computers 16 and 18 and the mobile device 20 each have a processor for executing software to implement functions of a social network shopping community as described herein. Although the mobile device 20 is shown in FIG. 1 as connected directly to the computer 16, it is understood that the mobile device 20 can communicate wirelessly to a base station or other wireless access point, which in turn can communicate using the communications network 12. Also, although reference is made herein to the computer 16, it is understood that such reference is made solely for ease of explanation and that such references apply equally to the computer 18. The server 14 also has a processor to execute software 24 to implement functions of the social network shopping community described herein. In one embodiment, software for implementing functions of the social network shopping community may be downloaded to the computers 16 and 18 and to the mobile device 20 via the communications network 12 from the server 14.

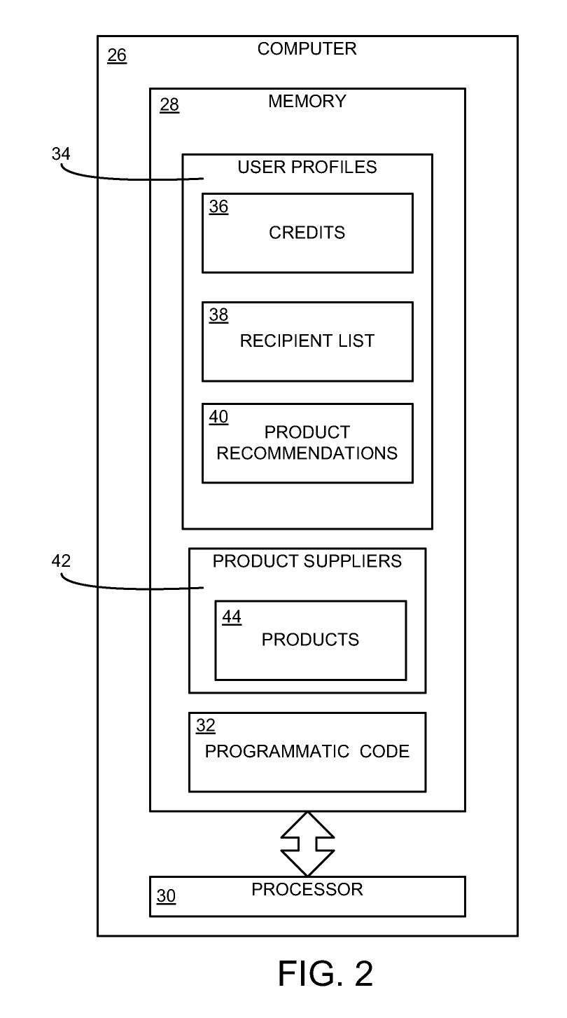

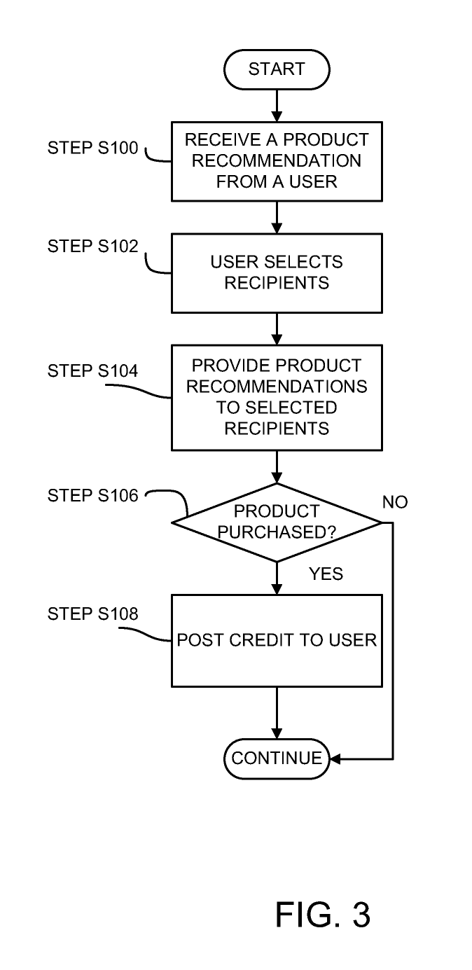

FIG. 2 is a block diagram of a computer 26 to implement functions of the social network shopping community described herein. The computer 26 may function as the computer 16 or 18, or may function as the mobile device 20, or may function as the server 14. The computer 26 has a memory 28 and a processor 30. Although not shown, the computer 26 includes those interfaces and programmatic code needed to allow the computer 26 to communicate with other devices using the communications network 12. The memory 28 has programmatic code 32, i.e., software, that is executable by the processor 30 to implement social network shopping community functions described herein. The memory 28 may be volatile, non-volatile or a combination of the two, such as Read Only Memory, Random Access Memory, fixed and/or removable discs, flash memory, etc. The memory 28 stores one or more user profiles 34. A user profile 34 may comprise a list of credits 36 awarded to the user for recommending products sold by a product supplier. The memory 28 also stores one or more recipient lists 38 to who the user may recommend products. The memory 28 also stores a list of one or more product recommendations 40 of one or more users. The memory 28 may also include a list of product suppliers 42 and their products 44. The computer 26 may perform functions described in connection with the flow charts of FIGS. 3-6.

Thus, one embodiment is a system that provides a combined social network and shopping network. The system can be implemented using one or more computers, each computer having a memory 28 and a processor 30. The memory stores user information that includes user identifying information and user product recommendations. The processor 30 associates a product recommendation with a list of recipients designated by a user who recommends the product. The processor 30 also provides credit to the user when a designated recipient purchases the recommended product. The amount and details of the credits are stored in the memory 28 in user profiles 34. The processor 30 may also filter information to prohibit user information from being transmitted to an unauthorized third party. The processor 30 may also receive a request for a product recommendation and search a database for a recommendation in response to the request.

FIG. 3 is a flow chart of an exemplary process for receiving product recommendations and crediting the recommending user when a recommended product is purchased by one who received the recommendation. The user of the computer 16 or the mobile device 20 inputs a recommendation (step S100). This recommendation may be stored on the computer 16 or the mobile device 20, and is also sent to the server 14. In addition to inputting one or more product recommendations, the user may also select recipients to receive the recommendation (step S102). For example, the server 14 may provide a web page for the user that includes information identifying the user, products recommended by the user, and uniform resource locators (URLs) that link to product information. The user may recommend a product by selecting a product link and selecting a list of recipients to receive the link (step S104).

There may be a single recipient or a group of recipients. For example, the user may have previously designated certain individuals who communicate via the network 12 as “friends.” The friends of the user are typically persons known by the user or are trusted friends of the user's friends. A friend or other person may communicate with the user using the computer 16 or the mobile device 20 via the network 12. The list of friends or other recipient list may be stored on the server 14. The server 14 is thus a host server of the social network shopping community. In some embodiments, more than one server may be employed to perform the functions described herein.

The user may make a recommendation of a product to the selected recipients (step S104). For example, the user may post a link to information concerning the product on a virtual “wall” of a recipient. As another example, the product recommendation may be sent by email to one or more recipients simultaneously. As another example, the user may be involved in a chat with one or more recipients about one or more products via an instant messaging service hosted by the social network shopping community server 14. The user may send a link to product information to the one or more chatting recipients via the instant messaging service.

In another embodiment, the user may invite and take a group of recipients on a virtual shopping tour. When a recipient receives the invitation, the recipient may select a link that opens a window on the recipient's computer monitor that displays one or more virtual store fronts and one or more product categories of products sold by each store. The user may control the tour by selecting a particular store front, in response to which the user and recipients are taken “inside” the store. For example, a window may open on the display of the computer 16 or the mobile device 20 for the user as well as the recipients' displays to display products sold by the store. The user may then recommend a displayed product and may also solicit and receive comments concerning the product or store from one or more recipients on the shopping tour.

Subsequent to the product recommendation, a determination is made that a recipient has purchased a recommended product (step S106). When this happens, the server determines a credit amount to credit an account of the recommending user (step S108). The credit amount may be, for example, an amount of money, discount or incentive applied to a subsequent purchase by the user.

Thus, one embodiment is a social network shopping community method. The method includes storing user information that includes user identifying information, user product recommendations and links to information concerning recommended products. At least some of the user information may be displayed at a web site along with the links to product information. The method includes receiving a product recommendation from the user and transmitting the product recommendation to one or more recipients designated by the user. The recipients may be chosen from a list of friends of the user. The method also includes storing the product recommendation and the list of designated recipients in a data base.

When one of the designated recipients purchases a recommended product, credit is given to the user who recommended the product. The server 14 stores an amount of credit for each user. The credit may represent a dollar amount in an account that can be applied to a purchase by a user to whom the credit belongs. Or the credit may be an amount of “points” that are equivalent to a dollar amount. The stored user information may be updated when a user recommends a new product. The method may also include displaying a list of products purchased by the user. The method may further include enabling the user to search product recommendations of other users to obtain at least one product recommendation. The method may also include storing a list of persons recruited by a user to participate in the social network shopping community. Credit may be earned based on the number of persons recruited. Different categories of users may be established. For example, a level one user may be able to recommend the products of level two users, whereas a level two user may recommend its own products.

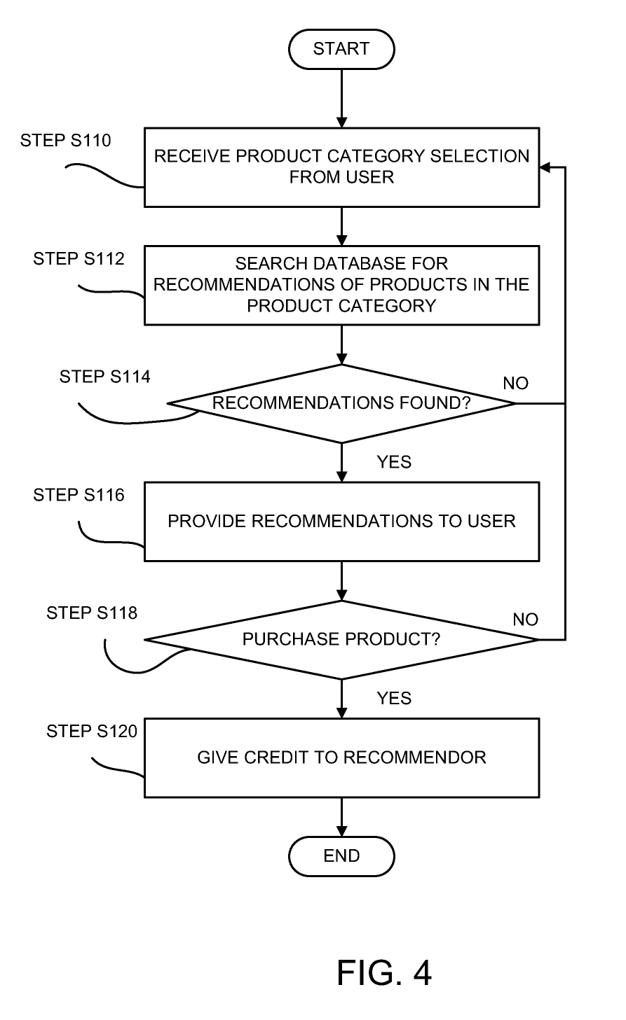

FIG. 4 is a flow chart of an exemplary process for receiving and processing a request for recommendation of a product by a user. A user selects a product category for which he or she seeks a recommendation (step S110). For example, a monitor of the user's computer 16 or mobile device 20 may display a list of product categories from which to choose, e.g., “furniture polish.” A user may select this category to seek a recommendation of a product in this category. Upon receipt of the category selection of the user, the server 14 may search a database for recommendations of products in the selected category (step S112). The database can be provided on the server 14 as part of memory 28 or on a separate device in communication with the server. The server 14 may then find and transmit the recommendation of a product in the product category to the computer 16 or the mobile device 20 (step S114). The recommendation may be accompanied by the identification of the person who made the recommendation.

For example, the server may search its database in response to selection of the furniture polish category, and find a recommendation for “Lemon PLEDGE.” The recommendation may be just a few words such as “works great,” or may be a number on a scale from 1 to 10 such as “7”. Or the recommendation may be one or more sentences such as “This product works best. I have tried product X, which does not work nearly as well.”

The recommendation for the product found in the database of server 14 may then be sent to the user who requested the recommendation (step S116). The identification of the person who made the recommendation may also be sent to the user who requested the recommendation. If the user then purchases the product (step S118), a credit amount may be given to the person who made the recommendation relied upon by the user (step S120).

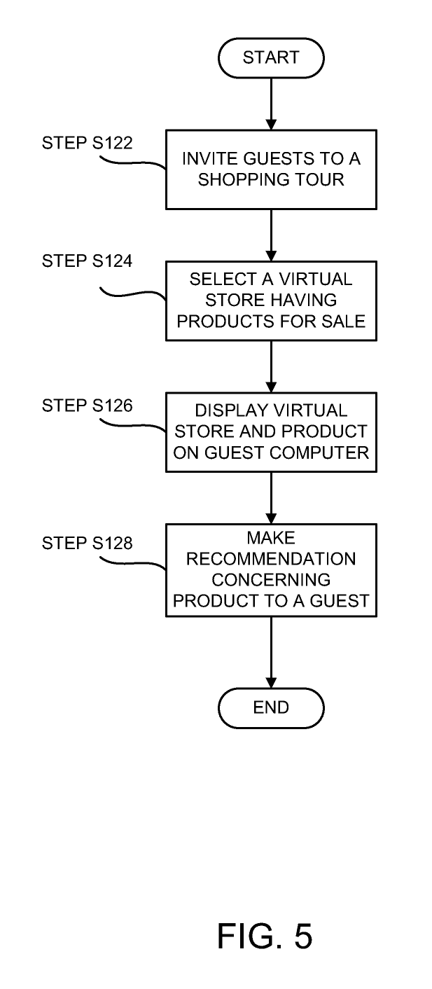

FIG. 5 is a flow chart of an exemplary process for taking a group of recipients on a virtual shopping tour. A host invites guests to participate in the virtual shopping tour (step S122). Upon acceptance of the invitation, one or more guests may view one or more virtual store fronts on the monitor of a computer 18 or mobile device 20 of the recipient. The host may then select a particular store by clicking on its store front icon or link (step S124). The monitors of the invited guests may then display the inside of the store showing various products sold by the store (step S126). During the tour, the host and invited guests may make suggestions and recommendations concerning products for sale (step S128).

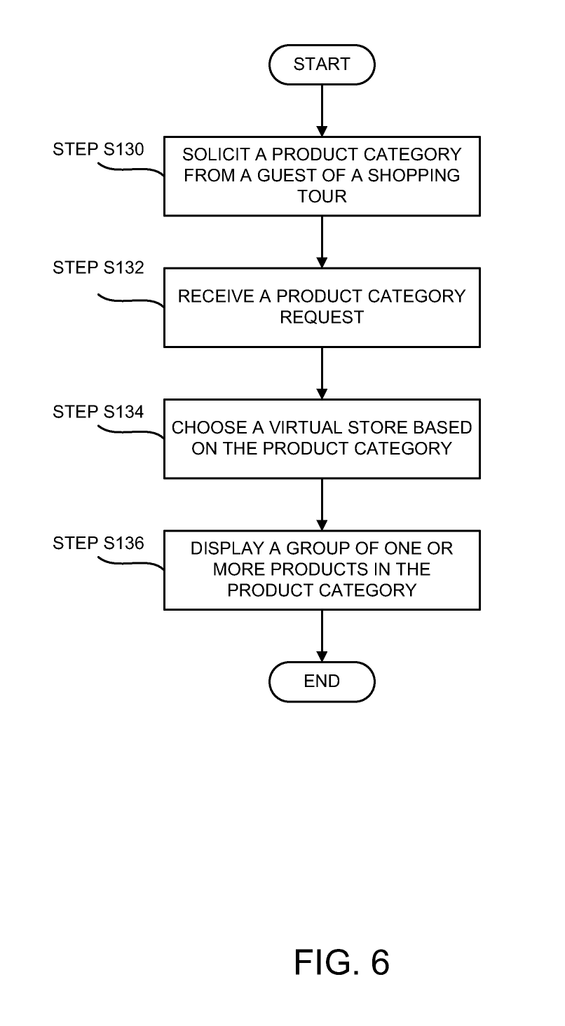

FIG. 6 is a flow chart of an exemplary process for soliciting product categories from guests on a virtual shopping tour. The host of the shopping tour solicits a product or product category from one or more guests on the tour (step S130). The host receives one or more product categories from the guests (step S132). The host of the shopping tour chooses a virtual store based on the product category (step S134). For example, if the product category suggested by a guest is “printers,” the host may choose the store, “BEST BUY,” or “OFFICE DEPOT.” The monitor of the guest's computer 18 or mobile device 20 may then display one or more of the products offered by the selected store (step S136).

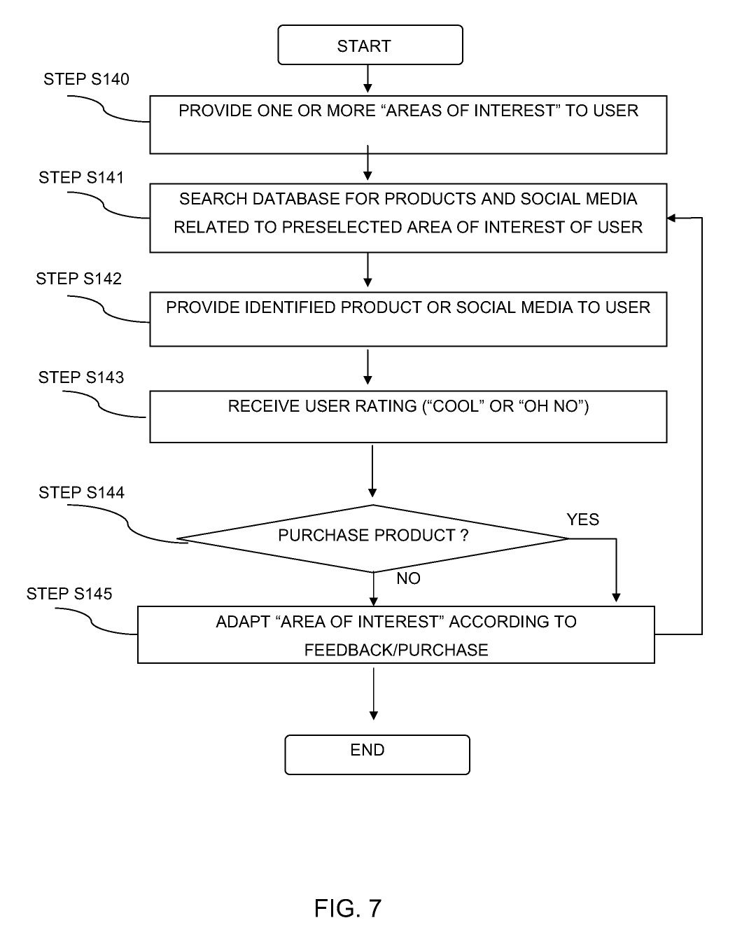

FIG. 7 is a flow chart of an exemplary process for a product discovery method for a user. In an exemplary embodiment, a user preselects one or more product categories of interest (step S 140). For example, the user's computer 16 or mobile device 20 may display a list of areas of interests (such as sports, travel, fashion, etc.) from which to choose. The user may preselect one or more of such areas to start the product discovery process. Upon receipt of the preselection of the user, the server 14 may search a data base for products and social media in the preselected area (step S141). The data base can be provided on the server 14 as part of memory 28 or on a separate device in communication with the server 14. The server 14 may then find and transmit products and/or social media in the preselected area of interest to the computer 16 or the mobile device 20 (step S142). The user may provide comments on the transmitted product or social medium, e.g. by clicking a “like/cool” or “dislike/oh no” button (step S143). A possible comment may also be “I don't want to comment this product/social medium.” Other ratings are possible such as a number rating using numbers from e.g. zero (“unlike it very much”) to ten (“like it very much”). Based on such feedback the server 14 may focus its search by way of adaption of the area of interest (step S145) and search and provide the next product or product medium (step S141/142). Independent of the individual rating, the user may decide to purchase an offered product or not (step S144).

In an exemplary embodiment of the discovery process, the server 14 alternately transmits products and social media. The process is therefore from the user's point of view comparable to browsing a (paper) magazine in which content, such as photographs and/or reports are displayed with commercials on an alternate basis. An advantage to the user is that the system is able to focus on the real interests of the user so that the user is not “swamped” with products and social media not of interest.

By providing feedback to the server as described above, the server learns the preferences of a specific user and focuses subsequent transmissions according to the user's interest. This is illustrated by the following example: A user may preselect “sports” as one area of interest. He may then receive social media, such as photographs or videos or reports about various sport events alternating with sport products such as sport equipment. The server may send, on a random basis as explained above (in the frame of the preselection), photos and/or products related to soccer, hockey and judo. If the user clicks the “oh no” button for the soccer and judo transmissions, whereas he or she clicks the “cool” button for the hockey products the server will learn that the user is focused on hockey (rather than on soccer and judo) and will thereinafter provide hockey products and social media according to said user focus. In this embodiment of the invention (product discovery mode) the social media are usually sent by the users. The user may upload social media of his or her interests to the server 14. The social medium may contain tags explaining which areas of interest are related to the social medium. By analyzing the various social media uploaded by an individual user the server 14 may already focus the area of interests for subsequent transmissions. By way of example: If an individual user uploads only soccer pictures to the server the server will conclude that the user is mainly interested in soccer and will therefore focus the area of interest for this individual user to soccer.

The embodiment of the invention described above, i. e. the products discovery method can of course be combined with other embodiments of this system such as the recommendation of other users described above.

Thus, one embodiment is a virtual shopping method. The method includes inviting at least one guest to a shopping tour. The method includes selecting at least one virtual store having products for sale. The selected virtual store is displayed on a computer of the at least one guest. The method may also include making a recommendation concerning at least one product for sale at the virtual store to the at least one guest. The host of the tour may receive feedback concerning the product from the at least one guest. The host may also solicit and receive a product category request from a guest. The host may choose a particular virtual store based on the product category request.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

Therefore, another embodiment is a computer readable medium containing computer readable instructions that, when executed by the computer, cause the computer to perform social network shopping community functions. The functions include receiving a product recommendation and an indication of intended recipients. The intended recipients may include a group of friends of the user. The functions also include providing the product recommendation to the intended recipients. The functions may also include notifying an intended recipient of the product recommendation by email. The functions may also include posting the product recommendation on a web page accessible by an intended recipient.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A social network shopping community method, comprising:
storing user information for each of a plurality of users, the user information including user identifying information and user preselected areas of interest;
displaying social media and product information for each user according to the preselected area of interest;
receiving feedback from the user;
adapting the preselected area of interest and product information according to the user feedback;
storing the adapted area of interest and product information; and
displaying updated social media and product information for each user according to the adapted area of interest.

2. The method of claim 1, wherein the product information includes a web link to purchase the product.

3. The method of claim 1, further comprising including displaying a list of products purchased by a user with the user information.

4. A system providing a social and shopping network site on a wide area network, the system comprising:
at least one computer having:
a memory storing user information, the user information including user identifying information and user dependent areas of interest; and
a processor in communication with the memory, the processor:
associating the user dependent areas of interest with a list of products and social media; and
receiving ratings for products and social media from the individual user and adapting the user dependent area of interest according to the rating of said user.
